(19) United States
(12) Patent Application Publication
(10) Pub. No.: US 2010/0320224 A1
(43) Pub. Date: Dec. 23, 2010

(54) System for Avoiding Excessive Pressure while Discharging Compressed Gas Cylinders

(75) Inventors: Steven W. Lampe, Westlake Village, CA (US); David W. Pang, Beijing (CN)

Correspondence Address: BRACEWELL & GIULIANI LLP, P.O. BOX 61389, HOUSTON, TX, 77208-1389, US

(73) Assignee: NEOgas Inc., Spring, TX (US)

(21) Appl. No.: 12/703,587

(22) Filed: Feb. 10, 2010

Related U.S. Application Data
(60) Provisional application No. 61/151,330, filed on Feb. 10, 2009.

(51) Int. Cl. G01F 11/00

(52) U.S. Cl. 222/1

(57) ABSTRACT

A system and method of safely discharging hydraulic fluid from a compressed gas cylinder, comprises filling first and second compressed gas cylinders with compressed gas. A compressed gas dispensing system has a pump that pumps hydraulic oil into the compressed gas cylinders to maintain a desired pressure while gas is dispensed. Gas is dispensed from the first cylinder while hydraulic fluid is pumped into the cylinder to maintain the desired pressure. Once the first cylinder is depleted, the hydraulic oil is discharged from the first cylinder. The process is repeated for the second cylinder. However, the hydraulic oil must be discharged from the second cylinder before the substantial depletion of the gas. To safely discharge the hydraulic oil, compressed gas from the second cylinder is distributed into the first cylinder. Once the second cylinder has reached a safe discharge pressure or volume, the hydraulic fluid is discharged.

### CROSS REFERENCE TO RELATED APPLICATIONS

This application claims the benefit of and priority to U.S. Provisional Patent Application No. 61/151,330, filed on Feb. 10, 2009, and herein incorporated by reference in its entirety.

### FIELD OF THE INVENTION

This invention is a system and method for avoiding excessive pressure while discharging a compressed gas cylinder in a compressed gas dispensing system.

### BACKGROUND OF THE INVENTION

Compressed natural gas (CNG) is any natural gas that has been processed and treated for transportation, in bottles or cylinders, at ambient temperature and at a pressure approaching the minimum compressibility factor.

Natural gas is colorless, odorless, and lighter than air, and it easily dissipates into the atmosphere when it leaks. It burns with a flame that is almost invisible, and it has to be raised to a temperature above 620° C. in order to ignite. By way of comparison, it should be noted that alcohol ignites at 200° C. and gasoline at 300° C. For safety reasons, natural gas is odorized with sulfur for marketing purposes.

Natural gas is an alternative to oil and therefore, it has great strategic importance, since it is a fossil fuel found in porous subsurface rock. It usually has low levels of pollutants, similar to nitrogen, carbon dioxide, water and sulfur compounds that remain in a gaseous state at atmospheric pressure and ambient temperature. Compressed natural gas is stored at a pressure of 220 bars or 3190 psi and is transported in trailers of varying volumetric capacity, depending on legislation and customer/project requirements.

The principal advantage of using natural gas is the preservation of the environment. In addition to economic benefits, it is a non-polluting fuel and it burns cleanly, so its combustion products that are released into the atmosphere do not need to be treated.

The great need to transport and store natural gas has contributed to increasing gas research around the world. Various methods have been proposed for storing and transporting compressed gases, such as natural gas, in pressurized vessels for overland transportation. The gas is typically stored and transported at high pressure and low temperature to maximize the amount of gas contained in each gas storage system. For example, compressed gas must be in a dense single-fluid state characterized as a very dense gas with no liquid.

CNG is typically transported over land in tanker trucks or tank wagons. Tankers have storage containers such as pressurized metal vessels. These storage vessels have high burst strengths and withstand the ambient temperature at which CNG is stored.

In some instances, hydraulic fluid is pumped into compressed gas cylinders to maintain a desired pressured throughout the dispensing operation. Once a cylinder has been substantially depleted, the hydraulic oil is discharged from the cylinder. Often times, a semi-trailer of cylinder modules needs to be transported from a dispensing site before all of the cylinders have been fully depleted. There are numerous safety risks associated with discharge of hydraulic oil from a compressed gas cylinder containing a large volume of compressed gas due to the rate at which the gas will expand and the velocity with which the hydraulic oil will exit the cylinder.

A new technique is necessary to permit, the safe discharge of hydraulic fluid from a compressed gas cylinder containing a substantial amount of gas. The following technique may solve one or more of these problems. The present technique exceeds the deficiencies described by providing a system and method that is capable of dispensing and distributing gas in one compressed gas cylinder to another compressed gas cylinder or across many compressed gas cylinders to reach a safe discharge pressure or volume. A system is utilized to safely discharge hydraulic fluid from a compressed gas cylinder.

### SUMMARY OF THE INVENTION

Applicant has recognized a need for a system and method for safely discharging hydraulic oil from a compressed gas cylinder.

An embodiment of the system and method of this invention has a fixed and/or stationary modular unit having a hydraulic fluid tank, a pressurization pump, and a compressed gas transportation system having a plurality of compressed gas cylinders. Each cylinder has two ports, a hydraulic fluid charging/discharging port and a gas dispensing port, with actuated valves positioned at each port. A valve is connected at the dispensing port of each cylinder, with the valves at the dispensing ports of each cylinder also being connected to one another.

Gas is dispensed from the dispensing port of the cylinder by opening the valve at the dispensing port. Gas is dispensed from a first cylinder to a motor vehicle. Hydraulic fluid is simultaneously pumped into the first cylinder as the compressed gas is dispensed, thereby maintaining a desired pressure until the first cylinder is exhausted. The hydraulic fluid from the first cylinder is discharged from the first cylinder by closing the valve at the dispensing port and opening the valve at the charging/discharging port. Once the hydraulic fluid is discharged, the valve at the charging/discharging port of the first cylinder is closed. Gas is simultaneously dispensed to a motor vehicle from a second compressed gas cylinder. Hydraulic fluid is simultaneously pumped into the second cylinder as the compressed gas is dispensed to thereby pressurize the cylinder to a desired dispensing pressure.

Due to circumstances at times, it may be necessary to discharge the hydraulic fluid in the second cylinder before the gas in the second cylinder has been substantially depleted. A safe discharge pressure based on the volume of gas remaining in the second cylinder, or alternatively a safe discharge volume of gas, is calculated. The valves on the dispensing ports of the first and second cylinders are opened. A portion of the gas remaining in the second cylinder is distributed into the first cylinder until the pressure in the second cylinder reaches a safe discharge pressure or a safe discharge volume is of gas reached. Once the second cylinder has reached a safe discharge pressure or a safe discharge volume of gas, the valves at the dispensing ports of the first and second cylinders are closed. The valve at the charging/discharging port of the second cylinder is opened and the hydraulic oil is safely discharged from the second cylinder.

### BRIEF DESCRIPTION OF THE DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic of a compressed gas filling system. It illustrates the operation of the hydraulic pressurization equipment (HPU) connected to an over-the-road semi trailer.

FIG. 2 is a flow chart of the operating steps of the system for avoiding excessive pressure.

FIG. 3 is a schematic of an example of the system for avoiding excessive pressure.

### DETAILED DESCRIPTION OF THE INVENTION

The present invention now will be described more fully hereinafter with reference to the accompanying drawings in which a preferred embodiment of the invention is shown. This invention may, however, be embodied in many different forms and should not be construed as limited to the embodiment set forth herein; rather, this embodiment is provided so that this disclosure will be thorough and complete, and will fully convey the scope of the invention to those skilled in the art. Like numbers refer to like elements throughout.

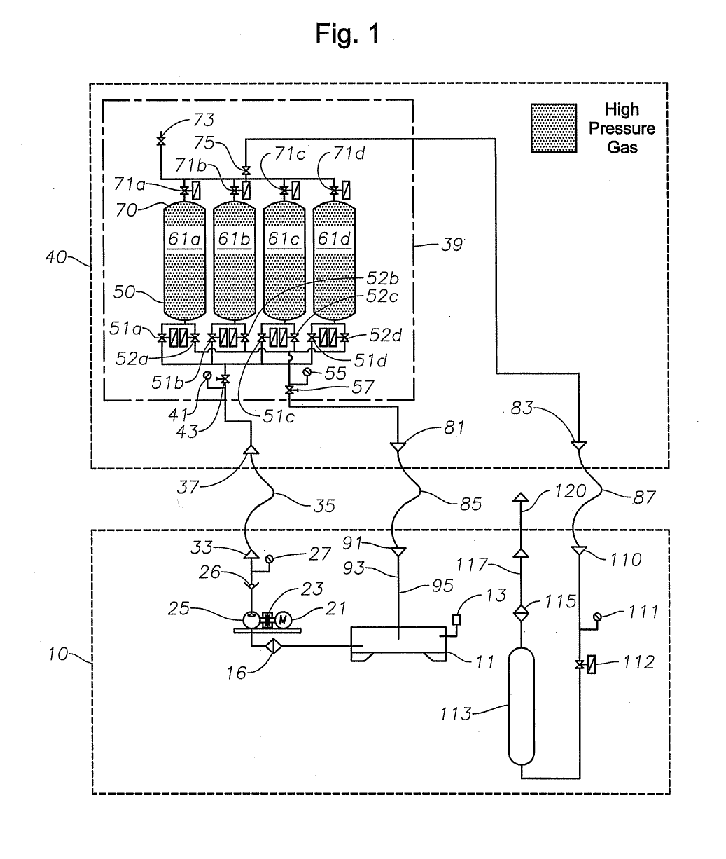

FIG. 1 illustrates a compressed gas dispensing system comprising a hydraulic pressurization unit (HPU) 10, which is connected to an over-the-road compressed gas semi trailer 40.

As illustrated by FIG. 1, the HPU 10 comprises a hydraulic fluid tank 11, a hydraulic level gauge 13, a particle filter 16, a motor 21, a coupling 23, a pump 25, a check valve 26, a pressure sensor 27, an outgoing fluid line 33, and a fluid return line 91. Additionally, the HPU 10 comprises a capacity control sensor 93, a photoelectric control sensor 95, an incoming gas line 110, a pressure sensor 111, an actuated ball valve 112, a hydraulic fluid separator 113, a coalescing filter 115, and an outgoing gas dispensing line 117. An electric/electronic control panel (not shown), and programmable logic controller software complete the HPU 10.

The over-the-road compressed gas semi trailer 40 is comprised of a gas cylinder module 39. In additional embodiments, the gas semi trailer 40 may contain more than one cylinder module. In this particular embodiment, gas cylinder module 39 comprises a grouped plurality of horizontal (tubular) cylinders 61a-d. In this embodiment, each of the cylinder 61a-d has the same volume capacity; however, cylinders in additional embodiments may have different volume capacities. The cylinders 61a-d carry compressed gas. For example, cylinders 61a-d may carry compressed natural gas (CNG), hydrogen, and other compressed gases. The gas cylinder module 39 has a charging end 50 and a dispensing end 70. Pressure gauges 41, 55 and a set of valves comprising manual ball valves 43, 57 and actuated ball valves 51a-d, 52a-d are connected at the charging end 50 of the module 39. The upstream connection from the actuated ball valves 51a-d is connected to an incoming fluid line 37. The downstream connections from the actuated ball valves 52a-d are connected to a fluid return line 81.

A number of valves comprising actuated ball valves 71a-d, a manual ball valve 75, and a pressure relief valve 73 are connected at the dispensing end 70 of the cylinder module 39. The downstream connection from the actuated ball valves 71a-d is connected to an outgoing gas line 83. The over-the-road semi trailer 40 is charged with compressed gas at another location. Once the cylinder module 39 is filled with compressed gas to a desired pressure, for example 220 bar or 3190 psi, the semi trailer 40, including the cylinder module 39, is transported to a gas dispensing station where the HPU 10 is installed. The semi trailer 40 is connected to the HPU 10 with three hoses: an outgoing fluid hose 35, a return fluid hose 85, and an outgoing gas hose 87. The HPU 10 ensures that the compressed gas cylinders 61a-d are charged to a specific pressure throughout the dispensing operation. In order to accomplish this, the HPU 10 pumps hydraulic oil into the cylinders 61a-d as gas is dispensed, in order to maintain the desired specific pressure.

In order to dispense gas from the cylinder module 39, the start button on the control panel (not shown) is pushed and the HPU 10 begins unloading compressed gas from the first cylinder 61a in the compressed gas module 39. The electronic control panel sends a signal to the actuated ball valve 112 on the HPU 10, the actuated ball valve 51a on the charging end 50 of the module 39, and the actuated ball valve 71a on the dispensing end 70 of the module 39, thereby causing the valves 112, 51a, 71a to open, and allowing the compressed gas in the first cylinder 61a to be dispensed. The compressed gas dispensed from the first cylinder 61a flows through the outgoing gas line 83 and the outgoing gas hose 87 before reaching the incoming gas line 110 of the HPU 10. When the gas reaches the incoming gas line 110 of the HPU 10, the gas flows through the pressure sensor 111, the actuated ball valve 112, the hydraulic fluid separator 113, the coalescing filter 115, the dispensing line 117, and into a compressed gas delivery line 120. As the gas is dispensed from the first cylinder 61a of the module 39, the pressure sensor 27, located downstream of the check valve 26, senses the pressure drop in the first cylinder 61a. When the pressure within the first cylinder 61a reaches a selected level, such as 210 bar or 3046 psi, or less, the sensor 27 sends an electrical signal to the control panel. The control panel then sends a signal that actuates the motor 21.

The motor 21 suctions hydraulic fluid from the hydraulic fluid tank 11, forcing it through the particle filter 16 to the pump 25. The pump 25 forces the hydraulic fluid through the check valve 26, the outgoing fluid line 33, and the outgoing fluid hose 35, until it reaches the incoming fluid line 37 of the over-the-road semi trailer 40. The hydraulic fluid flows through the actuated ball valve 51a and into the first cylinder 61a, thereby increasing the pressure and forcing the gas from the first cylinder 61a out the dispensing end 70 of the module 39. Once the pressure sensor 27 senses the gas pressure has reached a selected pressure, such as 220 bar or 3190 psi, an electronic signal from the control panel switches off the motor 21. The check valve 26 prevents hydraulic fluid from flowing back into the hydraulic fluid tank 11.

The compressed gas is dispensed and the process discussed above is repeated until the volume of hydraulic fluid in first cylinder 61a reaches 95% of the total volume capacity of the first cylinder 61a. When the hydraulic fluid volume reaches 95% of the total volume capacity of the first cylinder 61a, a level gauge 13 connected to the hydraulic fluid tank 11 sends an electronic signal to the control panel and the control panel sends a signal to the motor 21, which had been on and now switches off. Simultaneously, the actuated ball valves 51a, 71a are closed, and a signal is sent to the actuated ball valve 52a causing it to open.

The gas occupying the residual 5% of the total capacity of the first cylinder 61a tends to expand, making the hydraulic fluid that had been forced into the first cylinder 61a return to hydraulic fluid tank 11, flowing through the valve 52a, the return line 81, the return hose 85, the incoming return line 91, and into the hydraulic fluid tank 11.

When the capacitance sensor 93 or the photoelectric sensor 95 detects gas in the return line 91, the sensor sends an electrical signal to the control panel, which then sends a signal to the actuated ball valve 52a, which had been open and now closes, thereby shutting down the return of hydraulic fluid to the hydraulic fluid tank 11.

When the discharge of hydraulic fluid from the first cylinder 61a begins, the control panel begins unloading gas from the second cylinder 61b in the module 39 (beginning another cycle). The cycle is repeated for each cylinder 61a-d in the module 39 until each cylinder 61a-d in the module 39 has been exhausted. Although this particular embodiment discusses a single module 39 containing four compressed gas cylinders 61a-d, the number of cylinders in a module, and the number of modules on a semi trailer, depends solely on the volume of gas that needs to be transported and the manufacturing standards of the over-the-road semi trailer.

In some instances, a semi-trailer of cylinder modules needs to be transported from a dispensing site before all of the cylinders have been fully depleted. For example, in this particular embodiment, the first cylinder 61a and the second cylinder 61b in the module 39 have been fully exhausted and discharged, but the hydraulic fluid volume in the third cylinder 61c has not yet reached 95% of the total volume capacity of the third cylinder 61c. As a result, the residual percentage of the total volume capacity of the third cylinder 61c is occupied by gas, and is larger than 5%, and in some situations is often times much larger. The greater the volume of gas remaining in the third cylinder 61c, the lower the pressure in the third cylinder 61c must be in order to safely discharge the hydraulic fluid. For example, for a cylinder containing a gas volume of 50%, the maximum safe discharge pressure may be 300 psi or 20 bar, whereas for a cylinder containing a gas volume of 5%, the maximum safe discharge pressure may be 3190 psi or 220 bar. If the valve 52c on the charging end 50 of the module 39 was opened with the increased volume of gas remaining in the third cylinder 61c, the gas would rapidly expand, making the hydraulic fluid that had been forced into the third cylinder 61c return at an extremely high velocity to the hydraulic fluid tank 11, flowing through the valve 52c, the return line 81, the hose 85, and the HPU return line 91. The velocity of the hydraulic fluid returning to the hydraulic fluid tank 11 due to the rapid expansion of gas could result in a large quantity of gas entering the return line 81 and continuing downstream. In an alternate embodiment, the HPU 10 may have a vented hydraulic fluid tank. If the compressed gas reaches the return line 91, the compressed gas could also be blown through the hydraulic fluid tank 11, and out any vented areas.

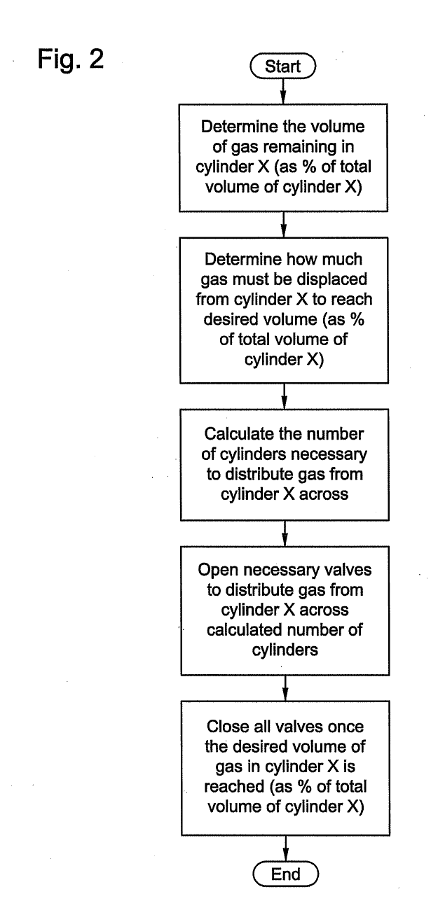

In order to reduce the risks associated with such a situation, a safety method, as illustrated by the flowchart in FIG. 2, is employed to ensure that a compressed gas cylinder is at a safe discharging volume and corresponding pressure before discharge is initiated. As previously discussed, the lower the volume of compressed gas in a cylinder, the higher the pressure the cylinder can be safely discharged. A system is implemented to ensure that a compressed gas cylinder is at a safe discharge volume and pressure before discharge is initiated. For example, the system may ensure that the volume of compressed gas in a given cylinder is at 5% or less of the total volume capacity of the cylinder before discharge is initiated, thereby ensuring a safe discharge pressure. For illustration purposes, as previously discussed, the first cylinder 61a and the second cylinder 61b in the module 39 have been fully exhausted and discharged, but the hydraulic fluid volume in the third cylinder 61c has not yet reached 95% of the total volume capacity of the third cylinder 61c. Before discharge of the third cylinder 61c is initiated, the volume of hydraulic fluid in the third cylinder 61c is calculated by the control panel and logic control software based upon the flow rate of the pump 25 and the amount of time the pump 11 has pumped hydraulic fluid into the third cylinder 61c. The volume of gas remaining in the third cylinder 61c is then calculated as the difference between the total volume capacity of the third cylinder 61c and the volume of hydraulic fluid in the third cylinder 51c. In an alternate embodiment, the hydraulic fluid tank level gauge 13 may send a signal to the control panel, enabling it to determine the volume of hydraulic fluid, and the corresponding volume of gas remaining in the third cylinder 61c.

The control panel and the logic control software then use the calculated volume of gas remaining in the third cylinder 61c to calculate the pressure required to safely discharge the third cylinder 61c. For example, a safe discharge pressure for a compressed gas cylinder with a volume of gas equal to 50% of the total cylinder volume may be 20 bar or 300 psi. However, as previously discussed, the compressed gas in the cylinder is charged to a desired pressure for dispensing, for example, approximately 220 bar or 3190 psi, and therefore, the pressure must be reduced before the cylinder can be safely discharged. Once the control panel and the logic control software determine the required cylinder pressure for safe discharge of the third cylinder 61c, the control panel uses an algorithm to determine the number of cylinders that the remaining volume of gas must be distributed across in order to reach the desired discharge pressure, or alternatively, the desired volume of compressed gas for safe discharge. The control panel will detect the remaining pressure of the other cylinders 61a, 61b, 61d in the module 39 by using the pressure sensor 111. The control panel will combine this information with the distribution calculation and will determine which cylinder or cylinders are needed for dispersement. Any cylinder with a higher remaining pressure than cylinder 61c will not be used. In this example, cylinder 61d is fully pressurized with compressed gas, and as a result, will not be used. After the control panel identifies the cylinders needed for the appropriate dispersement, it then sends a signal to the appropriate valves on the dispensing end 70 of the cylinders 61a-d, causing them to open and receive compressed gas.

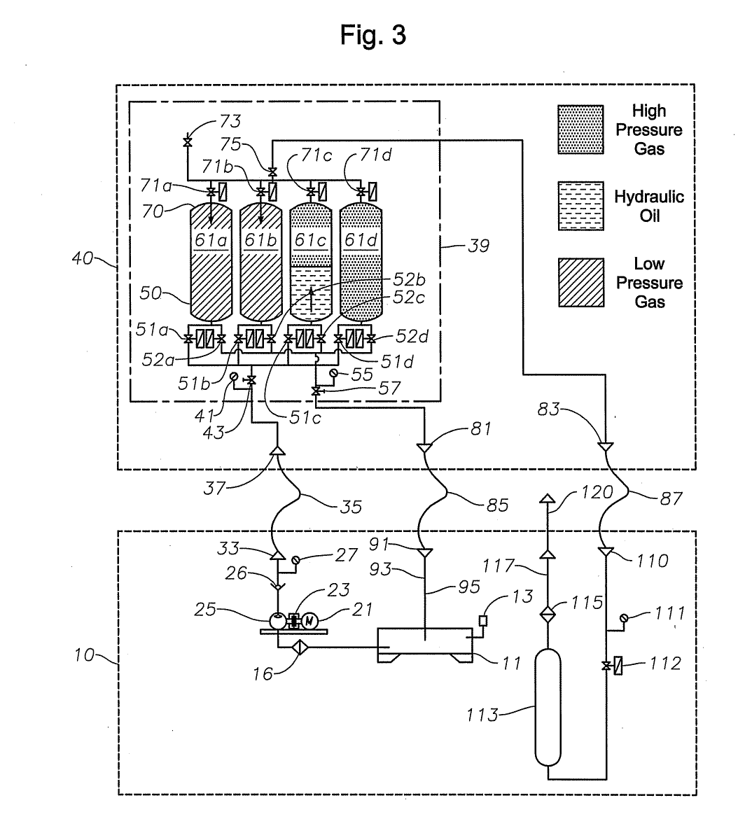

For example, as illustrated by FIG. 3, the control panel determines that a portion of the compressed gas remaining in the third cylinder 61c needs to be distributed across two cylinders, the first and second cylinders 61a, 61b in order to reach a safe discharge pressure or volume. The control panel sends a signal to the actuated ball valves 71a, 71b on the dispensing end 70 of the first and second cylinders 61a, 61b, causing them to open. The control panel simultaneously sends a signal to the actuated ball valve 71c on the dispensing end 70 of the third cylinder 61c, causing it to open. A portion of compressed gas, from the third cylinder 61c then flows through the valves 71a, 71b and into the first and second cylinders 61a, 61b. If the required safe discharge pressure can be reached by dispensing gas to the first and second cylinders 61a, 61b without reaching pressure equilibrium across the three cylinders 61a-c, the control panel then sends a signal to the actuated ball valves 71a-c, closing them once the gas has been distributed and the desired discharge pressure has been reached. The pressure sensor 111 is used to determine when the desired discharge pressure in cylinder 61c is reached. However, if pressures in the first, second, and third cylinders 61a-c equalize and a safe discharge pressure has not been reached, the control panel simultaneously sends a signal to motor 21, causing hydraulic fluid to be pumped into the third cylinder 61c. The hydraulic fluid entering the third cylinder 61c forces a portion of the remaining gas in the third cylinder 61c through the valves 71c, 71a, 71b and into the first and second cylinders 61a, 61b. Once a safe discharge volume of gas in the third cylinder 61c is reached, the control panel then sends a signal to the actuated ball valves 71a-c, 51c, thereby closing them and switching off the motor 21.

As previously discussed, the third cylinder 61c may now be safely discharged. A signal is sent to the actuated ball valve 52c causing it to open. The gas occupying the residual percentage of the total volume capacity of the third cylinder 61c tends to expand, making the hydraulic fluid that had been forced into the third cylinder 61c return to the hydraulic fluid tank 11, flowing through the valve 52c, the return line 81, the hose 85, the return line 91, and into the hydraulic fluid tank 11. When the capacitance sensor 93 or the photoelectric sensor 95 detects gas in the return line 91, the sensor sends an electrical signal to the control panel, which sends an electrical signal to the actuated ball valve 52c, which had been open and now closes, thereby shutting down the return of hydraulic fluid to the hydraulic fluid tank 11.

The embodiments of the present invention offer several advantages. The safety system ensures that hydraulic fluid in a compressed gas cylinder is never discharged if the volume of gas remaining in the cylinder or the pressure of the compressed gas in the cylinder is above a specified level. The safety system coordinates a method to dispense and distribute gas in one cylinder to another cylinder or across many cylinders to reach a safe discharge pressure or volume. This system ensures that the hydraulic fluid in the cylinder is discharged at a controllable rate due to the specified volume of gas remaining in the cylinder at discharge or the specified pressure of the gas, thus eliminating the possibility of a hydraulic fluid or gas blow out.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as set forth in the following claims.

1. A method of safely discharging hydraulic fluid from a compressed gas cylinder, the method comprising:
(a) mounting first and second cylinders on a transport vehicle;
(b) filling the cylinders with compressed gas;
(c) moving the transport vehicle to a compressed gas dispensing site;
(d) exhausting the first cylinder;
(e) pumping hydraulic fluid into the second cylinder to thereby pressurize the cylinder to a desired dispensing pressure;
(f) distributing compressed gas from the second cylinder into the first cylinder; and
(g) discharging the hydraulic fluid from the second cylinder.

2. The method of claim 1, wherein the method further comprises after step (c), but before step (d):
dispensing compressed gas from the first cylinder; and
pumping hydraulic fluid into the first cylinder as the compressed gas is dispensed.

3. The method of claim 2, wherein step (e) further comprises:
discharging the hydraulic fluid from the first cylinder.

4. The method of claim 1, wherein step (f) further comprises:
monitoring the volume of hydraulic fluid in the second cylinder;
calculating a safe discharge pressure based on the volume of gas remaining in the second cylinder; and
distributing compressed gas from the second cylinder into the first cylinder until the pressure in the second cylinder reaches a safe discharge pressure.

5. The method of claim 1, wherein step (f) further comprises:
monitoring the volume of hydraulic fluid in the second cylinder;
calculating a safe discharge volume of gas for the second cylinder; and
pumping hydraulic fluid into the second cylinder to force gas from the second cylinder into the first cylinder until the second cylinder reaches a safe discharge volume of gas.

6. The method of claim 1, wherein step (g) further comprises:
opening a valve on the second cylinder, thereby allowing the volume of gas remaining in the second cylinder to expand and discharge the hydraulic fluid from the second cylinder.

7. A method of safely discharging hydraulic fluid from a compressed gas cylinder, the method comprising:
(a) mounting a first and second cylinder on a transport vehicle;
(b) filling the cylinders with compressed gas to a pressure;
(c) moving the transport vehicle to a compressed gas dispensing site;
(d) providing a compressed gas dispensing system with a pump;
(e) connecting the cylinders to the compressed gas dispensing system;
(f) exhausting the first cylinder;
(g) pumping hydraulic fluid into the second cylinder to thereby pressurize the cylinder to a desired dispensing pressure;
(h) distributing compressed gas from the second cylinder into the first cylinder; and
(i) discharging the hydraulic fluid from the second cylinder.

8. The method of claim 7, wherein the method further comprises after step (e), but before step (f):
dispensing compressed gas to a motor vehicle from the first cylinder; and
pumping hydraulic fluid into the first cylinder as the compressed gas is dispensed.

9. The method of claim 8, wherein step (g) further comprises:
discharging the hydraulic fluid from the first cylinder.

10. The method of claim 7, wherein step (h) further comprises:
monitoring the volume of hydraulic fluid in the second cylinder;
calculating a safe discharge pressure based on the volume of gas remaining in the second cylinder; and
distributing compressed gas from the second cylinder into the first cylinder until the pressure in the second cylinder reaches a safe discharge pressure.

11. The method of claim 7, wherein step (h) further comprises:
monitoring the volume of hydraulic fluid in the second cylinder;
calculating a safe discharge volume of gas for the second cylinder; and
pumping hydraulic fluid into the second cylinder to force gas from the second cylinder into the first cylinder until the second cylinder reaches a safe discharge volume of gas.

12. The method of claim 7, wherein step (i) further comprises:
opening a valve on the second cylinder, thereby allowing the volume of gas remaining in the second cylinder to expand and discharge the hydraulic fluid from the second cylinder.

13. A method of safely discharging hydraulic fluid from a compressed gas cylinder, the method comprising:
(a) mounting a first and second cylinder on a transport vehicle;
(b) filling the cylinders with compressed gas to a pressure;
(c) moving the transport vehicle to a compressed gas dispensing site;
(d) providing a compressed gas dispensing system with a pump;
(e) connecting the cylinders to the compressed gas dispensing system;
(f) dispensing compressed gas to a motor vehicle from the first cylinder, and
pumping hydraulic fluid into the first cylinder as the compressed gas is dispensed, until the first cylinder is exhausted;
(g) discharging the hydraulic fluid from the first cylinder and simultaneously dispensing compressed gas to a motor vehicle from second cylinder, and pumping hydraulic fluid into the second cylinder as the compressed gas is dispensed to thereby pressurize the cylinder to a desired dispensing pressure;
(h) distributing compressed gas from the second cylinder into the first cylinder; and
(i) discharging the hydraulic fluid from the second cylinder.

14. The method of claim 13, wherein step (h) further comprises:
monitoring the volume of hydraulic fluid in the second cylinder;
calculating a safe discharge pressure based on the volume of gas remaining in the second cylinder; and
distributing compressed gas from the second cylinder into the first cylinder until the pressure in the second cylinder reaches a safe discharge pressure.

15. The method of claim 13, wherein step (h) further comprises:
monitoring the volume of hydraulic fluid in the second cylinder;
calculating a safe discharge volume of gas for the second cylinder; and
pumping hydraulic fluid into the second cylinder to force gas from the second cylinder into the first cylinder until the second cylinder reaches a safe discharge volume of gas.

16. The method of claim 13, wherein step (i) further comprises:
opening a valve on the second cylinder, thereby allowing the volume of gas remaining in the second cylinder to expand and discharge the hydraulic fluid from the second cylinder.
